(19) United States
(12) Patent Application Publication
(10) Pub. No.: US 2025/0293365 A1
(43) Pub. Date: Sep. 18, 2025

(54) FIBER-REINFORCED POLYMER BATTERY ENCLOSURES, COMPOSITE COMPONENTS, AND METHODS WITH INTEGRATED POLYMER SEALS

(71) Applicant: GM GLOBAL TECHNOLOGY OPERATIONS LLC, Detroit, MI (US)

(72) Inventors: Erik B. Golm, Sterling Heights, MI (US); Venkateshwar R. Aitharaju, Troy, MI (US)

(73) Assignee: GM GLOBAL TECHNOLOGY OPERATIONS LLC, Detroit, MI (US)

(21) Appl. No.: 18/602,462

(22) Filed: Mar. 12, 2024

(51) Int. Cl. H01M 50/227; B29C 70/48; B29K 63/00; B29K 105/08; B29K 105/20; B29K 307/04; B29K 607/00; B29K 627/18; B29K 683/00; B29L 31/00; B60L 50/60; C08J 5/24; H01M 50/249

(52) U.S. Cl. CPC H01M 50/227; B60L 50/60; C08J 5/24; H01M 50/249; B29C 70/48; B29K 2063/00; B29K 2105/089; B29K 2105/20; B29K 2307/04; B29K 2607/00; B29K 2627/18; B29K 2683/00; B29L 2031/7146; C08J 2363/00; H01M 2220/20

(57) ABSTRACT

Presented are fiber-reinforced polymer (FRP) composite components with integrated polymer parts, methods for making/using such FRP composite components, and vehicles equipped with battery packs sealed inside FRP battery enclosures by integrated elastomeric seals. An FRP composite component, such as a rigid battery tray basin, includes a component body that is formed with a polymer matrix material, such as a fast-curing epoxy resin. A fiber preform, such as a multiaxial-fiber fabric sheet, is encapsulated within the component body and formed with a cluster of fibers bound together in a predefined formation. A polymer seal, such as an elastomeric bulb seal, includes a seal head and a mounting base. The seal's mounting base is stitched to the fiber preform and at least partially encapsulated within the component body. The seal head protrudes from the fiber preform and extends through an aperture in the component body.

### STATEMENT REGARDING FEDERALLY SPONSORED RESEARCH AND DEVELOPMENT

This invention was made with U.S. Government support under Contract No. DE-EE0009204 between General Motors, LLC, and the United States Department of Energy (DOE), Office of Energy Efficiency and Renewable Energy. The U.S. Government has certain rights in the invention.

### INTRODUCTION

The present disclosure relates generally to fiber-reinforced polymer (FRP) composite components. More specifically, aspects of this disclosure relate to traction battery packs sealed inside FRP battery enclosures using elastomeric seals.

Current production motor vehicles, such as the modern-day automobile, are originally equipped with a powertrain that operates to propel the vehicle and power the vehicle's onboard electronics. In automotive applications, for example, the vehicle powertrain is generally typified by a prime mover that delivers driving torque through an automatic or manually shifted power transmission to the vehicle's final drive system (e.g., differential, axle shafts, corner modules, road wheels, etc.). Automobiles have historically been powered by a reciprocating-piston type internal combustion engine (ICE) assembly due to its ready availability and relatively high energy density, light weight, and overall efficiency. Such engines include compression-ignited (CI) diesel engines, spark-ignited (SI) gasoline engines, two, four, and six-stroke architectures, and rotary engines, as some non-limiting examples. Hybrid-electric and full-electric vehicles (collectively “electric-drive vehicles”), on the other hand, utilize alternative power sources to propel the vehicle and, thus, minimize or eliminate reliance on a fossil-fuel based engine for tractive power.

A full-electric vehicle (FEV)-colloquially labeled an “electric car”—is a type of electric-drive vehicle configuration that altogether omits an internal combustion engine and attendant peripheral components from the powertrain system, relying instead on a rechargeable energy storage system (RESS) and a traction motor for vehicle propulsion. The engine assembly, fuel supply system, and exhaust system of an ICE-based vehicle are replaced with a single or multiple traction motors, rechargeable battery cells, and battery cooling and charging hardware in a battery-based FEV. Hybrid-electric vehicle (HEV) powertrains, in contrast, employ multiple sources of tractive power to propel the vehicle, most commonly operating an internal combustion engine assembly in conjunction with a battery-powered or fuel-cell-powered traction motor. Since hybrid-type, electric-drive vehicles are able to derive their power from sources other than the engine, HEV engines may be turned off, in whole or in part, while the vehicle is propelled by the electric motor(s).

### SUMMARY

Presented below are FRP composite components with integrated polymer parts, methods for making and methods for using such FRP composite components, and motor vehicles equipped with traction battery packs sealed inside FRP battery enclosures using integrated elastomeric seals. By way of illustration, and not limitation, methods are presented for manufacturing an FRP composite component (e.g., battery enclosure tray or lid) that has an integrated elastomeric part (e.g., extruded rubber bulb seal) embedded in the component. Prior to forming the component, the elastomeric part is stitched onto a complementary surface of a fiber preform (e.g., a multiaxial 0/45/−45 dry woven cloth layup made from carbon, glass, or aramid fibers). Once mated, the fiber preform with stitched-on elastomer part is placed into a mold cavity (e.g., two-part die mold of resin transfer molding (RTM) system); a polymer-matrix encapsulant (e.g., fast-curing epoxy resin) is injected into the mold cavity and cured to create a single-piece, rigid composite component integral with the elastomeric part. The final FRP composite component may take on innumerable shapes and sizes, including flat, curved, and irregular shapes as well as both closed-form and open-formed three-dimensional (3D) geometries. Moreover, the elastomeric part may be rigidly fixed to the fiber preform using various stitching techniques, including chain or tricot stitches using nylon or polyester threads.

Disclosed concepts, while not per se limited, may be particularly advantageous for fabricating a watertight battery pack enclosure with a load-bearing battery tray that is integrally formed as a unitary, one-piece structure with an extruded elastomeric bulb seal. In this instance, a mounting base portion of the embedded elastomer seal follows the contours of the fiber preform and, thus, the FRP battery tray such that the compressible seal head protrudes upward from an interface flange of the tray. When compared to current tray designs employing adhesives, fasteners, gaskets, or two-shot injection molding, stitching the elastomer seal onto the fiber preform ensures accurate seal location and retention during molding. An extruded bulb seal geometry may include a flat and flanged mounting base that is tangential to the seal head and parallel with the mating surface of the fiber preform; this in-line or parallel base allows a stitching needle to pass through the seal and preform to form a loop of thread that secures together the two pieces.

Disclosed FRP composite components with integrated polymer seals may be fabricated using various suitable polymer forming techniques, including resin transfer molding, vacuum infusion molding, injection molding, compression molding, etc. For RTM processes, grooves and protrusions may be added to the die face of the top mold tool to enclose therein and fluidly seal the seal structure to allow the seal head to remain flexible and not be coated with resin during the molding process. It may be desirable that some or all of the seal mounting base be encapsulated within the cured epoxy resin, whereas substantially all of the seal head is exposed through and protrudes from the resin. The seal may be fabricated from a variety of different polymeric materials, including natural and synthetic rubbers, polytetrafluoroethylene (PTFE), or silicone, and may contain one or more fillers and additives, such as graphite, ceramic (e.g., silicone, alumina, zirconium), wear-resistant carbon powders, etc. In the same vein, the polymer-matrix encapsulant may comprise epoxy resin, phenolic resin, polyurethane (PU) resin, etc. For PTFE-based seal materials, one or more select surfaces of the mounting base may be roughened to enhance bonding to the encapsulant, such as by sanding (e.g., 120-320 grit), abrasive blasting (e.g., non-abrasive media), plasma etching, printing, or chemical etching (e.g., using sodium naphthalenide in dimethyl sulfoxide (DMSO) to create rougher, chemically active surface).

FRP composite components with integrated elastomer parts may be implemented for both automotive and non-automotive applications alike, including the creation of articulating FRP composite components with integrated elastomeric joints. Moreover, disclosed methods for manufacturing FRP composite components with integrated elastomer parts may help to eliminate the need for adhesives, fasteners, gasket frames, specialized tooling, etc., for connecting the seal to the final assembly. In addition to obvious cost savings, disclosed designs and methods may also help to reduce part complexity, part weight, manufacturing time, and attendant warranty issues. Moreover, the integrated elastomer part may be stitched to a single FRP composite preform or multiple preforms, may be surface-mounted or edge-mounted to the preform(s), and may function as a seal, a joint, a plug, or other functional part.

Aspects of this disclosure are directed to FRP composite component with integrated polymer parts. In an example, an FRP composite component is fabricated with a rigid component body that is formed, in whole or in part, from a polymer matrix material. A fiber preform, which is formed from a cluster of fibers bound together in a predefined formation, is surrounded by and encased within the component body. To provide a sealing interface with a mating part, the FRP composite component is integrally formed with a polymer seal. This seal has a mounting base that is stitched to the fiber preform and at least partially encapsulated within the polymer matrix material of the component body. The polymer seal also has a seal head that protrudes from the fiber preform and extends through an aperture in the component body.

Additional aspects of this disclosure are directed to motor vehicles that contain rechargeable traction battery packs, which are sealed inside protective battery enclosures having an FRP battery tray with an integral elastomer seal. As used herein, the terms “vehicle” and “motor vehicle” may be used interchangeably and synonymously to include any relevant vehicle platform, such as passenger vehicles (ICE, HEV, FEV, fuel cell, fully and partially autonomous, etc.), commercial vehicles, industrial vehicles, tracked vehicles, off-road and all-terrain vehicles (ATV), motorcycles, farm equipment, aircraft, watercraft, spacecraft, e-bikes, etc. For non-automotive applications, disclosed concepts may be implemented for any logically relevant use, including stand-alone power stations and portable power packs, photovoltaic systems, pumping equipment, wind turbine farms, machine tools, server systems, etc.

In an example, a motor vehicle includes a vehicle body with a passenger compartment, multiple road wheels mounted to the vehicle body (e.g., via corner modules coupled to a unibody or body-on-frame chassis), and other standard original equipment. For electric-drive vehicle applications, one or more electric traction motors operate alone (e.g., for FEV powertrains) or in conjunction with an internal combustion engine assembly (e.g., for HEV powertrains) to selectively drive one or more of the road wheels to propel the vehicle. A rechargeable energy storage system with one or more traction battery packs is mounted onto the vehicle body and is operable to power the traction motor(s), in-vehicle accessories, a heating, ventilation, and air conditioning (HVAC) system, etc.

Continuing with the discussion of the foregoing example, the motor vehicle is also equipped with a battery enclosure that is mounted onto the vehicle body and encloses therein the traction battery pack. The battery enclosure includes a rigid and electrically insulating enclosure lid that is mounted on and sealed to a rigid and electrically insulating battery tray. The battery tray is formed, in whole or in part, with a polymer matrix material and a fiber preform that is encapsulated entirely within the polymer matrix material. This fiber preform is formed with a cluster of fibers that is bound together in a predefined formation. To seal the tray to the lid, the battery tray is integrally formed with an extruded elastomer seal having a seal head and a mounting base. The seal's mounting base is stitched to the fiber preform and at least partially encapsulated within the polymer matrix material. The seal head, in contrast, protrudes from the fiber preform, extends through an elongated slot in the battery tray, and is compressed against the enclosure lid.

Further aspects of this disclosure are directed to manufacturing systems, workflow processes, and control logic for making or for using any of the herein described FRP composite components, battery pack enclosures, and motor vehicles. In an example, a method is presented for forming a fiber-reinforced polymer composite component. This representative method includes, in any order and in any combination with any of the above and below disclosed options and features: receiving a fiber preform formed with a cluster of fibers bound together in a predefined formation; receiving a polymer seal with a seal head and a mounting base; stitching the mounting base of the polymer seal to the fiber preform; placing the fiber preform with the polymer seal stitched thereto into a mold; and forming a component body by injecting a polymer matrix material into the mold such that, once the polymer matrix material cures, the fiber preform is encapsulated within the component body, the mounting base is at least partially encapsulated within the component body, and the seal head protrudes from the fiber preform and extends through an aperture in the component body.

For any of the disclosed FRP composite components, vehicles, and methods, the polymer seal's mounting base may include a first (bottom) face that abuts the fiber preform, a second (top) face opposite the first face and at least partially exposed through the aperture in the component body, and opposing first (inner) and second (outer) edges extending between and connecting the first and second faces. In this instance, the first face, the first and second edges, and a portion of the second face are entirely covered by the polymer matrix material. As another option, the polymer seal may be stitched to the fiber preform via stiches that loop through the mounting base and the cluster of fibers. Optionally, the seal head may include an elongated and hollow bulb head, and the mounting base may include first (inner) and second (outer) flanges that are integrally formed with and project transversely from one side of the hollow bulb head. For edge mounted seal structures, the mounting base may include a single flange projecting radially from the seal head or two mutually parallel flanges projecting outwards from the seal head.

For any of the disclosed FRP composite components, vehicles, and methods, the polymer seal, including the seal head and mounting base, is integrally formed from an elastomeric material having an elasticity of at least about 0.45 gigapascals (GPa) or, in some implementations, about 0.85 GPa to about 2.35 GPa, and a melting point of at least about 145 degrees Celsius (° C.) or, in some implementations, about 165° C. to about 345° C. In this instance, the elastomeric material may be a natural or synthetic rubber, a polytetrafluoroethylene (PTFE) polymer, or a silicone polymer. As another option, the fiber preform may be embodied as a dry multiaxial-fiber fabric sheet. In this instance, the polymer matrix material may be embodied as a fast-curing epoxy resin with a cure time of about 3 minutes or less (e.g., 50-90 seconds) at about 100° C. to about 140° C.

For any of the disclosed FRP composite components, vehicles, and methods, the polymer seal's mounting base may be stitched to the fiber preform via a chain stitch or a tricot stitch using a polymer thread. In this instance, the polymer thread may be formed with a polyester material or a nylon material. As another option, the component body, the fiber preform, and the polymer seal are fabricated as a single-piece structure, joined to one another without adhesives, fasteners, brackets, etc. While not per se limited to battery applications or automotive applications, the component body may be shaped as a rigid battery tray that is contoured and sized to receive thereon a cluster of battery cells. Alternatively, the FRP component body may be shaped like a cylindrical shaft; in this instance, the polymer seal is toroidal and the seal head is a lip seal.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of a representative motor vehicle with a Rechargeable Energy Storage System (RESS) containing a traction battery pack that is sealed inside a fiber-reinforced polymer (FRP) battery enclosure with an integrated elastomer seal in accordance with aspects of the present disclosure.

FIG. 2 is a partially exploded, perspective-view illustration of a representative battery enclosure that includes an FRP composite battery tray formed with an integrated elastomer bulb seal in accordance with aspects of the present disclosure.

FIGS. 3A and 3B present a plan-view illustration (FIG. 3A) and a side-view illustration (FIG. 3B) of a representative FRP fabric layup with a sewn-on elastomer bulb seal in accordance with aspects of the present disclosure.

FIG. 4 is a cutaway, perspective-view illustration of a representative FRP composite shaft that is fabricated with an integrated lip-type shaft seal in accordance with aspects of the present disclosure.

FIGS. 5A-5C present cutaway, side-view illustrations of representative edge bulb seals sandwiched between and stitched to two FRP layups (FIG. 5A), sandwiching therebetween and stitched to one or more FRP layups (FIG. 5B), and interposed between, stitched to, and joining neighboring FRP layups (FIG. 5C) in accordance with aspects of the present disclosure.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless explicitly disclaimed: the singular includes the plural and vice versa (e.g., indefinite articles “a” and “an” are to be construed as meaning “one or more” unless expressly disclaimed); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

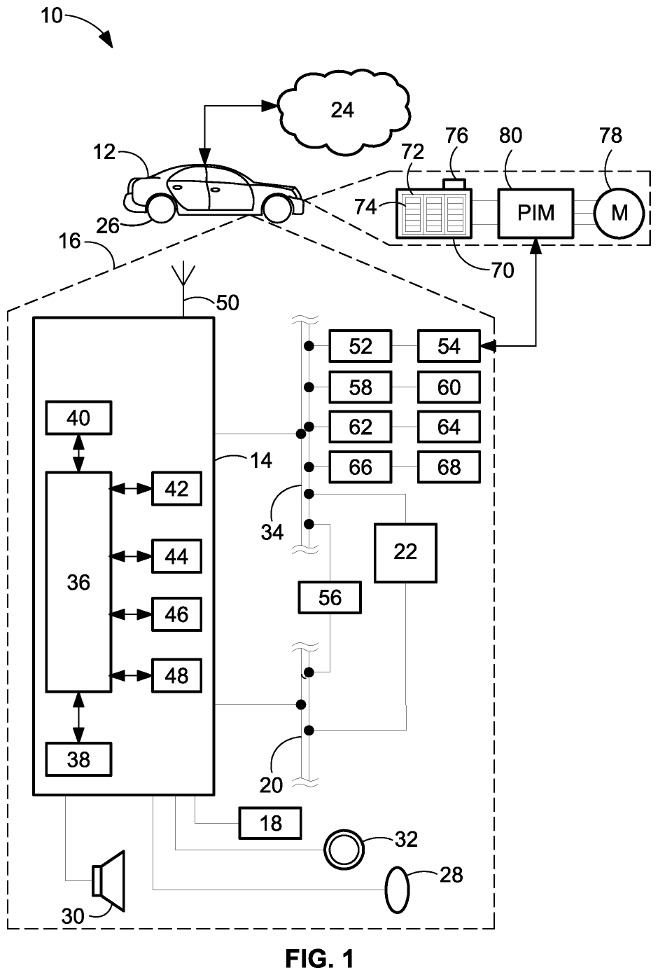

Referring now to the drawings, wherein like reference numbers refer to like features throughout the several views, there is shown in FIG. 1 a representative motor vehicle, which is designated generally at 10 and portrayed herein for purposes of discussion as a sedan-style, electric-drive automobile. The illustrated automobile 10—also referred to herein as “motor vehicle” or “vehicle” for short—is merely an exemplary application with which aspects of this disclosure may be practiced. In the same vein, incorporation of the present concepts into a battery enclosure for a traction battery pack should be appreciated as a non-limiting implementation of disclosed features. As such, it will be understood that aspects and features of this disclosure may be applied to other sealed enclosure designs, incorporated into any logically relevant type of motor vehicle, and utilized for both automotive and non-automotive applications alike. Moreover, only select components of the motor vehicles and battery assemblies are shown and described in detail herein. Nevertheless, the vehicles and batteries discussed below may include numerous additional and alternative features, and other available peripheral hardware, for carrying out the various methods and functions of this disclosure.

The representative vehicle 10 of FIG. 1 is originally equipped with a centerstack telecommunications and information (“telematics”) unit 14 that wirelessly communicates, e.g., via cell towers, satellite service, etc., with a remotely located cloud computing host service 24 (e.g., ONSTAR®). Other in-vehicle hardware components 16 shown in FIG. 1 include, as non-limiting examples, an electronic video display device 18, a microphone 28, audio speakers 30, and assorted user input controls 32 (e.g., buttons, knobs, switches, touchscreens, etc.). These hardware components 16 function as a human/machine interface (HMI) that enables a user to communicate with the telematics unit 14 and other components both resident to and remote from the vehicle 10. Microphone 28, for instance, provides occupants with means to input verbal commands. Conversely, the speakers 30 provide audible output to a vehicle occupant and may be either a stand-alone speaker dedicated for use with the telematics unit 14 or may be part of an audio system 22. The audio system 22 is operatively connected to a network connection interface 34 and an audio bus 20 to receive analog information, rendering it as sound, via one or more speaker components.

Communicatively coupled to the telematics unit 14 is the network connection interface 34, suitable examples of which include twisted pair/fiber optic Ethernet switches, parallel/serial communications buses, local area network (LAN) interfaces, controller area network (CAN) interfaces, and the like. Network connection interface 34 enables the vehicle hardware 16 components to send and receive signals with one another and with systems and subsystems both onboard and off-board the vehicle body 12. This allows the vehicle 10 to perform assorted vehicle functions, such as modulating powertrain output, activating a vehicle brake system, controlling vehicle steering, regulating charge and discharge of vehicle batteries, and other automated functions. For instance, the in-vehicle telematics unit 14 of FIG. 1 may receive and transmit signals to/from a Powertrain Control Module (PCM) 52, an Onboard Charging Module (OBCM) 54, an Electronic Battery Control Module (EBCM) 56, a Steering Control Module (SCM) 58, a Brake System Control Module (BSCM) 60, and assorted other vehicle ECUs.

With continuing reference to FIG. 1, telematics unit 14 is an onboard computing device that provides a mixture of services, both individually and through its communication with other networked devices. The telematics unit 14 may be generally composed of one or more processors 40, each of which may be embodied as a discrete microprocessor, an application specific integrated circuit (ASIC), or a dedicated control module. Vehicle 10 may offer centralized vehicle control via a central processing unit (CPU) 36 that is operatively coupled to an integrated circuit (IC) real-time clock (RTC) 42 and one or more electronic memory devices 38, each of which may take on the form of a CD-ROM, solid-state drive (SSD) memory, hard-disk drive (HDD) memory, semiconductor memory, etc.

Long-range communication (LRC) capabilities with off-board devices may be provided via a cellular communication chipset, a navigation and location component (e.g., global positioning system (GPS) transceiver), and/or a wireless modem, all of which are collectively represented at 44. Short-range communication (SRC) may be provided via a close-range wireless communication device 46 (e.g., a BLUETOOTH® unit), a dedicated short-range communications (DSRC) component 48, and/or a dual antenna 50. The above-described communications devices may provision data exchanges as part of a periodic broadcast in a vehicle-to-vehicle (V2V) communications system or a vehicle-to-everything (V2X) communications system. It should be understood that the vehicle 10 may be implemented without one or more of the above-listed components or, optionally, may include additional components and functionality as desired for a particular end use.

CPU 36 receives sensor data from one or more sensing devices that use, for example, photo detection, radar, laser, ultrasonic, optical, infrared, or other apposite technology, including short range communications technologies (e.g., DSRC) or Ultra-Wide Band (UWB) radio technologies, e.g., for executing an automated vehicle operation or a vehicle navigation service. In accord with the illustrated example, the automobile 10 may be equipped with one or more digital cameras 62, one or more range sensors 64, one or more vehicle speed sensors 66, one or more vehicle dynamics sensors 68, and any requisite filtering, classification, fusion, and analysis hardware and software for processing raw sensor data. The type, placement, number, and interoperability of the distributed array of on-vehicle sensors may be adapted, singly or collectively, to a given vehicle platform for achieving a desired level of autonomous vehicle operation.

To propel the motor vehicle 10, an electrified powertrain is operable to generate and deliver tractive torque to one or more of the vehicle's drive wheels 26. The powertrain is represented in FIG. 1 by an electric traction motor 78 that is connected to a rechargeable energy storage system (RESS), which may be in the nature of a chassis-mounted traction battery pack 70. The battery pack 70 may contain one or more battery modules 72 each housing a group of electrochemical battery cells 74, such as lithium-ion or lithium-polymer battery cells of the pouch, can, or prismatic type. One or more electric machines, such as a variable-speed, multiphase motor/generator (M) unit 78, draw electrical power from and, optionally, deliver electrical power to one or more rechargeable battery units, such as traction battery pack 70. A high-voltage (HV) electrical system with a power inverter module (PIM) 80 electrically connects the battery pack 70 to the motor/generator unit(s) 78 and modulates the transfer of electrical current therebetween. The battery pack 70 may be configured such that module management, cell sensing, and module-to-host communications functionality is integrated directly into each module 72 and performed wirelessly via a wireless-enabled cell monitoring unit (CMU) 76.

During operation of the motor vehicle 10 of FIG. 1, the battery pack 70 may be housed inside a protective and electrically insulating battery enclosure that is sealed closed to prevent the unwanted intrusion of moisture, debris, and contaminant gases into the battery cells 74. Sealing of the battery pack enclosure may be achieved using an elongated and elastomeric seal structure that is compressed between an enclosure lid and a mating battery tray. To minimize total part count, reduce assembly time, and simplify sealing of the pack, the battery enclosure may employ a unitary polymer-composite battery tray that is integrally formed with a compressible elastomer seal. The elastomer seal may be embedded in a mating surface of the battery tray using resin transfer molding (RTM), precision injection molding (PIJ), vacuum infusion molding (VIM), or other suitable molding processes. While illustrated and described below for use in a battery pack enclosure of an electric-drive automobile, it should be appreciated that disclosed concepts may be implemented for other enclosure configurations, implemented for innumerable types of vehicles, and may be implemented for automotive and non-automotive applications alike.

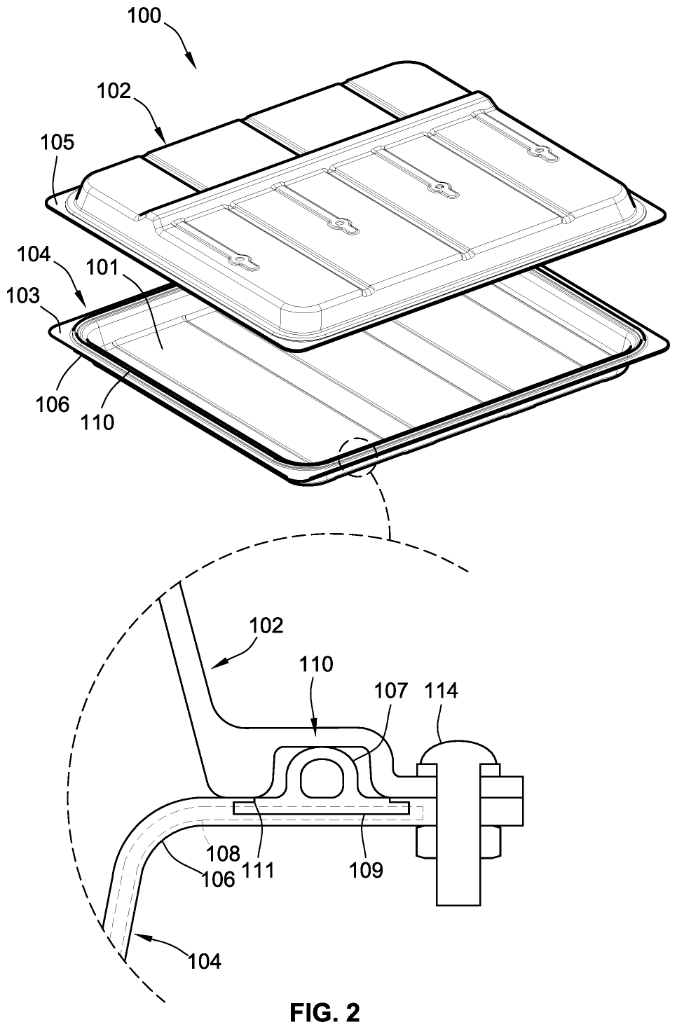

Turning next to FIG. 2, there is shown a non-limiting example of a fiber-reinforced polymer (FRP) composite component with an integrated polymer part embedded in the composite component. In particular, FIG. 2 presents a partially exploded, perspective-view illustration of a bipartite battery pack enclosure 100 that is generally composed of a rigid and electrically insulating FRP enclosure lid 102 that seats on top of and sealingly mounts to a rigid and electrically insulating FRP battery tray 104. The enclosure lid 102 may be mechanically fastened onto the battery tray 104 using an array of threaded fasteners 114. As shown, the battery tray 104 (also referred to below as “FRP composite component”) is a single-piece, unitary construction that is fabricated with a tray basin 106 (also referred to below as “component body”), a woven cloth layup 108 (also referred to below as “fiber preform”), and an extruded elastomer bulb seal 110 (also referred to below as “polymer seal”). Although not shown in FIG. 2, the battery tray 104 may include additional features to facilitate battery pack operation, including electrical feedthroughs, electrical headers, coolant line ports, fastener through-holes, etc.

Tray basin 106 is formed with a recessed cell platform 101 that is shaped and sized to support thereon a cluster of battery cells, such as rechargeable Li-ion battery cells 74 of FIG. 1. A rectangular tray flange 103 extends continuously around the upper extent of the cell platform 101 and mounts thereto a complementary lid flange 105 of the enclosure lid 102. Tray basin 106 is formed, in whole or in part, from a polymer matrix material that is suitable for use in molding an FRP composite component. For instance, the polymer matrix material may be a dimensionally stable, warp-resistant encapsulant in the nature of an epoxy resin, phenolic resin, polyurethane (PU) resin, etc. It may be desirable that the polymer matrix material be embodied as a low-viscosity, fast-curing thermoset epoxy resin with a cure time of about 3 minutes or less (e.g., 50-90 seconds) at a temperature of at least about 100 degrees Celsius (° C.) (e.g., 120-145° C.) and injected under a pressure of at least about 100 pounds per square inch (psi) (e.g., 150-300 psi).

To provide a lightweight yet high-strength part, a fiber preform 108 is encased within and, thus, completely surrounded by the polymer matrix material of the component body 106 to make up the internal structural skeleton of the FRP composite component 104. A “preform” may be typified as a cluster of fibers that is arranged in a predefined shape and bonded together, e.g., using a matrix-compatible binder resin. While it is envisioned that disclosed preforms may take on a variety of different shapes, sizes, and arrangements, the fiber preform 108 of FIG. 2 may be embodied as a multiaxial 0/45/−45 dry woven cloth layup that is made from continuous carbon, glass, and/or aramid fibers. A preform used in RTM and vacuum-assisted resin transfer molding (VARTM) processes may use a single layer or multiple layers of reinforcing fiber fabrics, including plain weave and twill weave cloths, or fabrics composed of chopped or continuous reinforcing fibers oriented uniaxially or multiaxially. It may be desirable, for at least some applications, that the FRP battery tray 104 have a thickness of between about 2 millimeters (mm) to about 8 mm or, in a more specific implementations, between about 3 mm and about 4 mm.

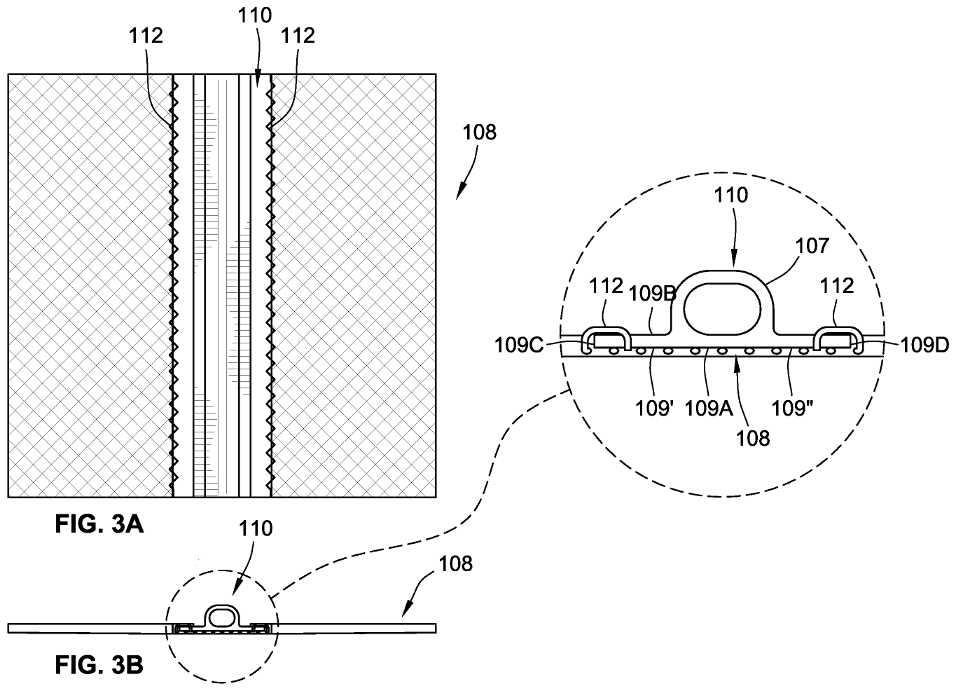

Integrated into the FRP composite component 104 of FIG. 2 is a polymer part 110 that is embedded in the component body 106 and rigidly mounted onto the fiber preform 108 via multiple loops of thread 112 (FIGS. 3A and 3B). Unlike many existing enclosure designs in which secondary polymer parts are mounted via fasteners, adhesives, or brackets to a primary composite component, disclosed polymer parts are integrally formed with the composite component by stitching the polymer part to the fiber preform and then molding the component body around the preform and select segments of the stitched-on part. In accord with the example illustrated in FIG. 2, the polymer part 110 is embodied as an extruded elastomeric seal with a compressible seal head 107 that is integrally formed with a flanged mounting base 109. The seal head 107 may include an elongated and hollow bulb head, whereas the mounting base 109 may include a pair of (first and second) flanges 109′ and 109″ that project transversely from a bottom side of the seal head 107. As best seen in FIGS. 3A and 3B, the seal's mounting base 109 is stitched onto a top surface of the fiber preform 108 with the seal head 107 protruding upwards from the fiber preform 108. After molding the component body 106, the mounting base 109 is partially encapsulated within the polymer matrix material of the component body 106 and the seal head 107 extends through an elongated slot-like aperture 111 in the top face of the component body's flange 103. It is envisioned that the polymer part 110 may take on alternative shapes, sizes, and configurations from those shown in the Figures, including varying types of seal structures including bulb seals with solid rubber heads.

With reference again to FIGS. 3A and 3B, the mounting base 109 portion of the polymer seal 110 may be fabricated with a substantially flat bottom (first) face 109A, a substantially flat top (second) face 109B parallel to and opposite the bottom face 109A, and a pair of opposing, mutually parallel inner (first) and outer (second) edges 109C and 109D, respectively, that are orthogonal to, extend between, and connect the top and bottom faces 109A, 109B. With this arrangement, the bottom face 109A of the polymer seal 110 structure sits flush against and directly contacts the fiber preform 108, whereas the top face 109B is partially exposed through the aperture 111 in the component body 108. After molding the component body 108, the bottom face 109A, the opposing edges 109C, 109D, and a portion of the top face 109B are covered by the polymer matrix material. To ensure compatibility with RTM and VaRTM processes, the polymer seal 110, including the seal head 107 and the mounting base 109, may be formed from an elastomeric material having an elasticity of at least about 0.45 gigapascals (GPa) or, in some implementations, about 0.85 GPa to about 2.35 GPa, and a melting point of at least about 145° C. or, in some implementations, about 165° C. to about 345° C. Within these design parameters, the elastomeric material may be a natural or synthetic rubber, a polytetrafluoroethylene (PTFE) polymer, a silicone polymer, or other RTM-compatible compressible material.

By stitching the seal to the preform and molding the component body around the seal-and-preform assembly, the polymer matrix body 106, the fiber preform 108, and the polymer seal 110 are fabricated into a unitary, single-piece structure and joined together without adhesives, fasteners, brackets, gasket frames, etc. The polymer seal 110 may be stitched to the fiber preform 108 via two series of stiches 112, each of which loops through a respective flange 109′, 109″ of the mounting base 109 and a respective segment of the cluster of fibers in the preform 108. While any appropriate stitching technique may be used, it may be desirable that the mounting base 109 portion of the polymer seal 110 structure be stitched to the fiber preform 108 via a chain stitch, tricot stitch, zigzag stitch, or continental stitch using a polymer thread. The polymer thread may be formed with a polyester material, a nylon material, or other high-temperature, high-pressure material that is compatible with the chosen molding process.

Also presented herein are manufacturing systems, workflow processes, and control logic for making or for using any of the herein described FRP composite components. In a non-limiting example, a method is presented for forming a fiber-reinforced polymer composite component, such as the FRP battery tray 104 of FIG. 2. This representative method includes, in any order and in any combination with any of the above and below disclosed options and features: forming, retrieving, or securing (collectively “receiving”) a fiber preform that is formed with a cluster of fibers bound together in a predefined formation, such as woven cloth layup 108; receiving a polymer seal with a seal head and a mounting base, such as elastomer bulb seal 110; stitching the mounting base of the polymer seal to the fiber preform, such as by polymer thread 112; placing the fiber preform with the polymer seal stitched thereto into a mold, such as a two-part die mold of an RTM system; and forming a component body by injecting a polymer matrix material, such as a fast-curing epoxy resin, into the mold such that the fiber preform is encapsulated within the component body, the mounting base is at least partially encapsulated within the component body, and the seal head protrudes from the fiber preform and extends through an aperture in the component body.

In the more specific yet non-limiting example, a one-piece, extruded rubber bulb seal is placed on a top face of a dry woven cloth layup. Transversely projecting flanges tangent to the round bulb head of the seal are then machine-stitched through the woven fibers of the layup. Once joined, the layup with in-stitched seal is then placed, e.g., using a manual or automated hand layup procedure, into a base mold tool of a two-part RTM die mold. The upper mold tool is then lowered onto and sealed with the base mold tool; a low-viscosity, fast-cure resin is then injected the closed mold assembly. After injecting and curing the resin, the cloth layup is encased within the resin encapsulant and the rubber bulb seal is embedded in the mounting flange of the resultant tray basin. In this example, the polymer stitches are also covered by and encapsulated within the resin matrix material of the tray basin.

Grooves and protrusions in the die face of the upper mold tool cooperatively enclose therein and fluidly seal the bulb head to allow the head to remain flexible and not be coated with resin during the molding process. For instance, the upper mold tool is precision-machined with a complementary square-ring-shaped channel that is recessed into the tool's downward-facing contact surface to receive therein the bulb head. A pair of downwardly projecting rails-one on each side of the recessed channel-press into the top face of the seal's mounting base to prevent the inadvertent ingress of resin during the molding process. The bulb seal flanges mate with these rails to create a sealing surface in the mold. The bottom face of the bulb seal's mounting base may be roughened to enhance bonding of the seal structure to the polymer matrix encapsulant material. It may be desirable that the polymer matrix material, the polymer seal material, and the polymer thread material be distinct from one another. By integrating the bulb seal into the battery tray, the enclosed battery pack can be serviced without having to discard and replace the seal or enclosure lid.

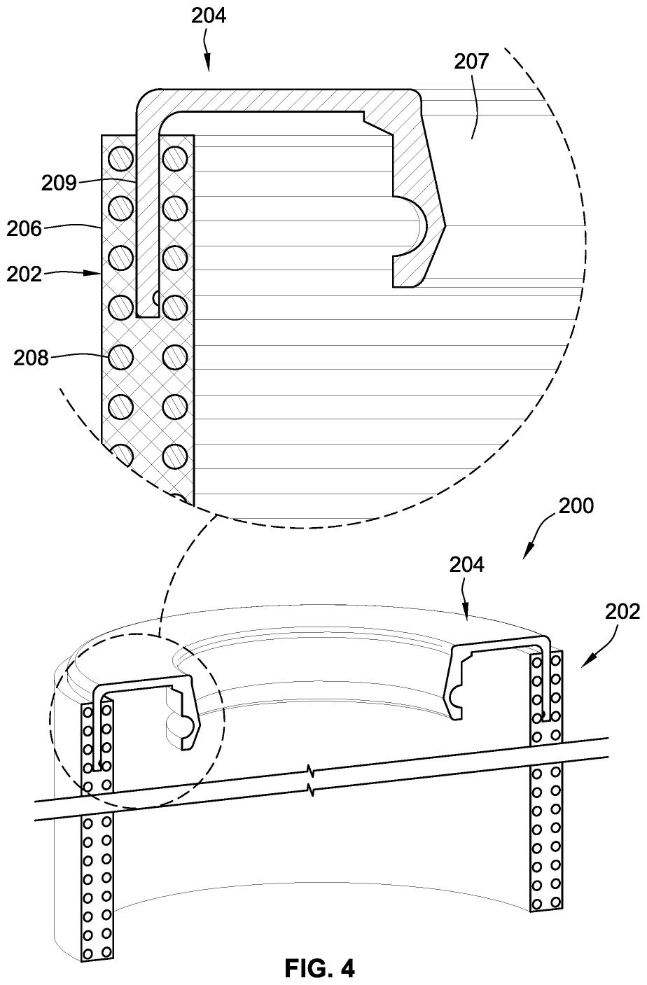

Turning next to FIG. 4, there is shown another non-limiting example of a fiber-reinforced polymer composite component with an integrated polymer part that is embedded in the composite component. In this example, a carbon fiber-reinforced polymer (CFRP) shaft assembly 200 is generally composed of a cylindrical shaft body 202 with an integrated elastomer shaft seal 204 embedded within the shaft body 202. The shaft seal 204 of FIG. 4 may be a one-piece construction that is formed from rubber and includes a flexible lip-type seal head 207 that projects radially inward from a toroidal mounting base 209. The elastomeric shaft seal 204 is secured to and covers the rim of an open longitudinal end of the shaft body 202. In this instance, the shaft seal 204 is wrapped in the middle of a carbon fiber tube body 206, which encases therein an epoxy-impregnated carbon fiber preform 208. Although differing in appearance, it is envisioned that the CFRP composite shaft assembly 200 of FIG. 4 may include any of the features and options described above with respect to the FRP battery tray 104 of FIG. 2, and vice versa. For instance, the seal's mounting base 209 may be stitched to the carbon fiber preform 208 and covered, in whole or in part, by the shaft's polymer matrix material. Optionally, the base 209 may be sandwiched between an outer wrap-around seal and an inner wrap-around mandrel that cooperatively attach the shaft seal 204 to the shaft body 202. Alternative designs may incorporate a flexible lip-type seal head that projects radially outward or axial from the toroidal mounting base.

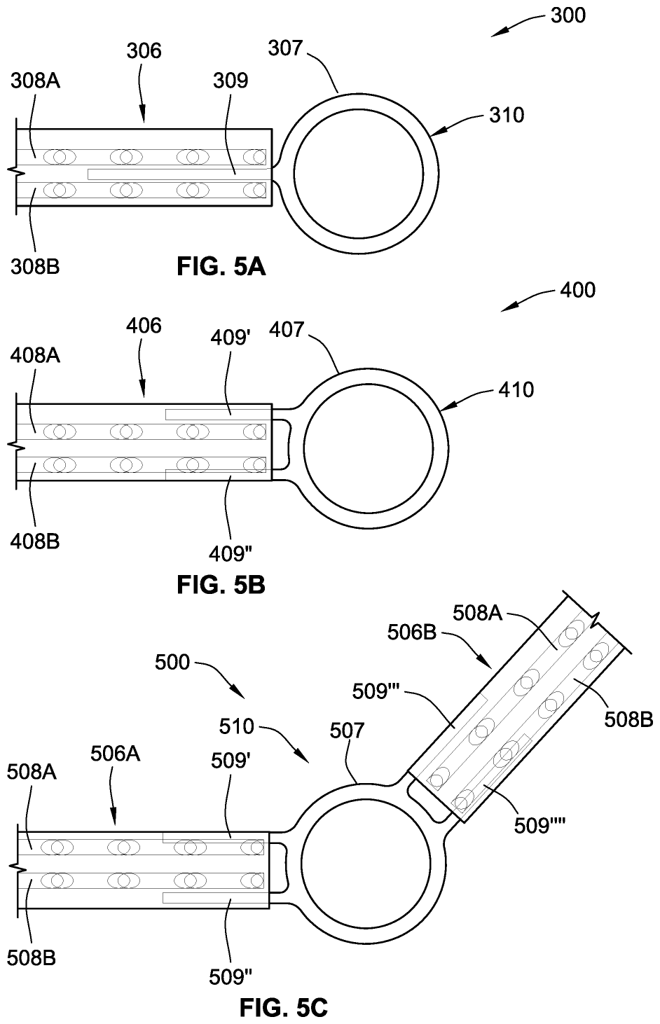

FIG. 5A illustrates an example of an FRP composite component 300 with an edge-type bulb seal 310 that projects outward from a terminal end of a component body 306. The component body 306 encapsulates therein a pair of mutually parallel fiber preforms 308A and 308B, which may extend substantially the entire length and width of the body 306. In this instance, the bulb seal 310 includes a circular seal head 307 with a single-flange mounting base 309 that projects radially outward from the seal head 307. The mounting base 309 of FIG. 5A is sandwiched between and stitched to the two preforms 308A, 308B such that most/all of the mounting base 309 is encapsulated within the polymer matrix material of the component body 306.

FIG. 5B illustrates another example of an FRP composite component 400 with an edge-type bulb seal 410 that projects outward from a terminal end of a component body 406. The component body 406 of FIG. 5B encapsulates therein a single or multiple mutually parallel fiber preforms 408A and 408B, which may extend substantially the entire length and width of the body 406. In this instance, the bulb seal 410 includes a circular seal head 407 with a pair of mounting base flanges 409′ and 409″ that both projects outward from the seal head 407 in the same direction (to the left in FIG. 5B). The two mounting base flanges 409′ and 409″ of FIG. 5B sandwich therebetween and stitch to a proximal edge of the preform(s) 408A, 408B such that both of the mounting base flanges 409′ and 409″ are encapsulated within the polymer matrix material of the component body 406.

FIG. 5C illustrates an example of a flexible FRP composite component 500 with an edge-type bulb seal joint 510 that extends between and connects terminal ends of two component bodies 506A and 506B. Each component body 506A, 506B of FIG. 5C encapsulates therein a single or multiple mutually parallel fiber preforms 508A and 508B. In this instance, the bulb seal joint 510 includes a circular seal head 507 with a first pair of mounting base flanges 509′ and 509″ that project outward from the seal head 507 in a first direction (to the left in FIG. 5C), and a second pair of mounting base flanges 509′″ and 509″ that project outward from the seal head 507 in a second direction (to the right in FIG. 5C) opposite the first direction. Each pair of mounting base flanges is stitched to a respective preform or a respective pair of preforms in a respective one of the component bodies. In addition to sealing, the bulb seal joint 510 creates an articulating joint that allows the flexible FRP composite component 500 to fold and unfold. The bulb seal joint 510 may also allow for swiveling, bending, hinging, and complex motion while maintaining a stiff panel structure.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A fiber-reinforced polymer (FRP) composite component, comprising:
a component body formed with a polymer matrix material;
a fiber preform encapsulated within the component body and formed with a cluster of fibers bound together in a predefined formation; and
a polymer seal with a seal head and a mounting base, the mounting base stitched to the fiber preform and at least partially encapsulated within the component body, and the seal head protruding from the fiber preform and extending through an aperture in the component body.

2. The composite component of claim 1, wherein the mounting base of the polymer seal includes a first face abutting the fiber preform, a second face opposite the first face and at least partially exposed through the aperture in the component body, and opposing first and second edges extending between and connecting the first and second faces.

3. The composite component of claim 2, wherein the first face, the first and second edges, and a portion of the second face are covered by the polymer matrix material.

4. The composite component of claim 1, wherein the polymer seal is stitched to the fiber preform via stiches looping through the mounting base and the cluster of fibers.

5. The composite component of claim 1, wherein the seal head includes a hollow bulb head and the mounting base includes first and second flanges projecting transversely from one side of the hollow bulb head.

6. The composite component of claim 1, wherein the polymer seal, including the seal head and the mounting base, is formed with an elastomeric material having an elasticity of at least about 0.45 gigapascals (GPa) and a melting point of at least about 145 degrees Celsius (° C.).

7. The composite component of claim 6, wherein the elastomeric material is a natural or synthetic rubber, a polytetrafluoroethylene (PTFE) polymer, or a silicone polymer.

8. The composite component of claim 1, wherein the fiber preform includes a dry multiaxial-fiber fabric sheet.

9. The composite component of claim 8, wherein the polymer matrix material includes a fast-curing epoxy resin with a cure time of about 3 minutes or less at about 100-140° C.

10. The composite component of claim 1, wherein the mounting base of the polymer seal is stitched to the fiber preform via a chain stitch or a tricot stitch using a polymer thread.

11. The composite component of claim 10, wherein the polymer thread is formed with a polyester material or a nylon material.

12. The composite component of claim 1, wherein the component body, the fiber preform, and the polymer seal are fabricated as a single-piece structure and joined together without adhesives and fasteners.

13. The composite component of claim 12, wherein the component body is shaped as a rigid battery tray configured to receive thereon a cluster of rechargeable battery cells.

14. A motor vehicle, comprising:
a vehicle body;
a plurality of road wheels attached to the vehicle body;
a traction motor attached to the vehicle body and configured to drive one or more of the road wheels to thereby propel the motor vehicle;
a traction battery pack attached to the vehicle body and configured to power the traction motor, the traction battery pack including a plurality of battery cells; and
a battery enclosure attached to the vehicle body and containing therein the traction battery pack, the battery enclosure including:
an enclosure lid; and
a battery tray sealed to the enclosure lid, the battery tray formed with a polymer matrix material and a fiber preform encapsulated entirely within the polymer matrix material, the fiber preform formed with a cluster of fibers bound together in a predefined formation, the battery tray integrally formed with an elastomer seal having a seal head and a mounting base, the mounting base stitched to the fiber preform and at least partially encapsulated within the polymer matrix material, and the seal head protruding from the fiber preform, extending through an elongated slot in the battery tray, and compressed against the enclosure lid.

15. A method of forming a fiber-reinforced polymer (FRP) composite component, the method comprising:
receiving a fiber preform formed with a cluster of fibers bound together in a predefined formation;
receiving a polymer seal with a seal head and a mounting base;
stitching the mounting base of the polymer seal to the fiber preform;
placing the fiber preform with the polymer seal stitched thereto into a mold; and
forming a component body by injecting a polymer matrix material into the mold such that the fiber preform is encapsulated within the component body, the mounting base is at least partially encapsulated within the component body, and the seal head protrudes from the fiber preform and extends through an aperture in the component body.

16. The method of claim 15, wherein the mounting base of the polymer seal includes a first face abutting the fiber preform, a second face opposite the first face and at least partially exposed through the aperture in the component body, and opposing first and second edges extending between and connecting the first and second faces.

17. The method of claim 15, wherein the seal head includes a hollow bulb head and the mounting base includes first and second flanges projecting transversely from one side of the hollow bulb head.

18. The method of claim 15, wherein the polymer seal, including the seal head and the mounting base, is formed with an elastomeric material having an elasticity of at least about 0.45 gigapascals (GPa) and a melting point of at least about 165 degrees Celsius (° C.).

19. The method of claim 15, wherein the fiber preform includes a dry multiaxial-fiber fabric sheet.

20. The method of claim 15, wherein the mounting base of the polymer seal is stitched to the fiber preform via a chain stitch or a tricot stitch using a polymer thread.
